(19) United States
(12) Patent Application Publication
(10) Pub. No.: US 2010/0175284 A1
(43) Pub. Date: Jul. 15, 2010

(54) Shoveling and Throwing Device

(76) Inventor: Wesley G. Chang, Dublin, OH (US)

Correspondence Address: Wesley Chang, 4847 Vista Ridge Drive, Dublin, OH, 43017, US

(21) Appl. No.: 12/730,202

(22) Filed: Mar. 23, 2010

Related U.S. Application Data
(63) Continuation-in-part of application No. 11/286,556, filed on Nov. 23, 2005, now Pat. No. 7,681,932.

(51) Int. Cl. E01H 5/02; B62B 1/14; E02F 3/02

(52) U.S. Cl. 37/434; 37/195

(57) ABSTRACT

A manual throwing device for shoveling and throwing a load of material including snow or debris.

### RELATED APPLICATIONS

This application claims priority to U.S. patent application Ser. No. 11/286,556, entitled “Shoveling and throwing device,” filed on Nov. 23, 2005, which issued as U.S. Pat. No. 6,681,932 on Mar. 23, 2010, having Wesley G. Chang listed as the inventor, the entire content of which is hereby incorporated by reference.

### TECHNICAL FIELD OF THE INVENTION

The present invention relates generally to shovels and methods of shoveling. More particularly, relating to a new and useful shovel for removing material, such as snow, from a surface.

### BACKGROUND OF THE INVENTION

The removal of snow from driveways is mostly accomplished by either using manual shovels or gasoline powered snow blowers. Snow blowers can be costly, dangerous, and environmentally destructive. Each year, hundreds of people suffer from maiming or amputations of their fingers or hands due to improper use of snow blowers. According to the U.S. Consumer Products Safety Commission, snow blower accidents are the fourth leading cause of finger amputations due to consumer products. There are more than 1,000 amputations and 5,000 hospital emergency-room-treated injuries every year with even deaths resulting from being caught in machinery and carbon monoxide poisoning. According to the EPA, a snow blower also sends a pound of carbon monoxide into the air each hour it runs, which compares to the emission from driving 70 miles on a passenger vehicle.

Manual shovels are simply to use and generally not expensive, however, they generally are not efficient and require significant physical exertion by the user. Also, improper use of manual shovels can cause significant back injuries and even lead to death for those who may not be in good physical condition. For most people, the act of shoveling their driveway or walkway is a physically exhausting task. The Journal of the American Medical Association found that people who rarely exercise are up to 30 times more likely to have a heart attack when they suddenly do something strenuous, such as snow shoveling. People often shovel first thing in the morning when heart attacks are more likely. According to the U.S. Consumer Products Safety Commission, intense exertion of shoveling snow, combined with the freezing cold, can make one's heart rate and blood pressure soar. In 2007, more than 118,000 people were treated in hospital emergency rooms, doctors' offices, clinics and other medical settings for injuries that happened while shoveling or removing ice and snow manually.

Back injuries due to snow shoveling can happen to anyone, not just older adults. People between the ages of 20 and 50 are generally more likely than older individuals to injure their backs because they may or may not be aware that they are out of condition. It is a repetitive activity that can cause muscle strain to the lower back and shoulders, especially if a person is not physically fit and does not lift properly. When bending forward to scoop the snow onto the shovel, one's center of gravity changes and it is easy to strain the low back muscles, especially the quadratus lumborum, a muscle which helps hold the body upright. According to a study published by Brad Coffiner at Cornell University's ergonomic department, the most severe injuries and pain are likely to occur in the back region, and the L5/S1 disc has been identified as the weakest link in the body segment chain when handling heavy snow with a shovel. When lifting and rotating to dump snow, the discs can cause the vertebrae to slip out of position, possibly herniate, which causes pressure on the nearby nerve roots or spinal cord. Back injury is the most prevalent physical damage that is supported by the fact that when lifting average snow weight of 17 pounds, 12 times per minute, one will have lifted over 2000 pounds of snow after 10 minutes and over 12,000 pounds in 1 hour.

There remains a need for a manual throwing device that reduces risk of injury and is efficient in removal of bulk material such as snow or debris.

### BRIEF DESCRIPTION OF THE DRAWINGS

FIG. 1 depicts an isometric view of one embodiment of the present invention.

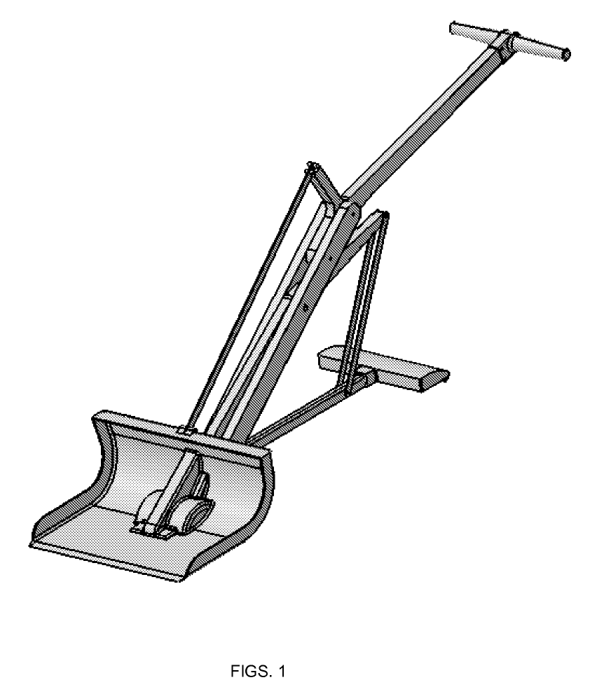

FIG. 2 depicts a side view of one embodiment of the present invention

FIG. 3 depicts an isometric view of the stopper

FIG. 4 depicts a bottom view of one embodiment of the foot pedal

FIG. 5 depicts an isometric view of one embodiment of the present invention in its second position.

FIG. 6 depicts one embodiment in a flat drawing that illustrates the transfer of force through the actuatable lever.

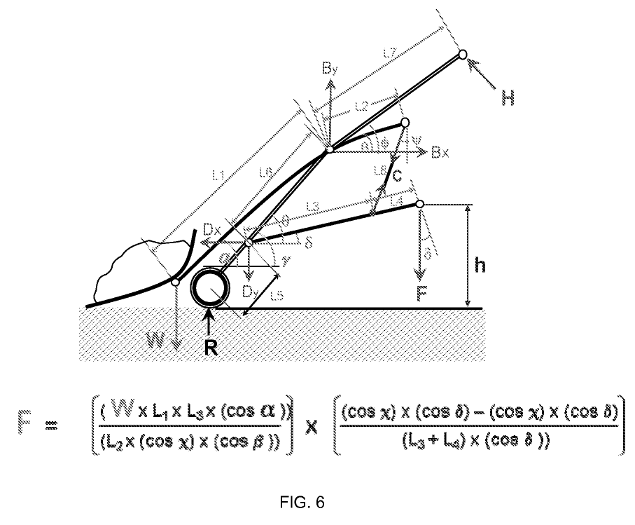

### DETAILED DESCRIPTION OF THE EMBODIMENT

In accordance with the foregoing summary of the invention, the following presents a detailed description of the embodiment of the invention.

To counter measure any known risk of injuries and pollution from using snow blowers or manual snow shovels when clearing snow, aspects of the present invention are designed to eliminate the danger of amputation, carbon monoxide poisoning, back injuries and reduce the chance of heart attack as a result of exhaustion, while having no adverse effect to the environment. In some embodiments, the present invention is an ergonomic snow thrower that is manually powered by operator's body weight, which eliminates the use of back during snow lifting and throwing process. In some embodiments, the present invention is a collapsible, manual debris throwing device that is collapsible to provide easy storage.

Some aspects of the present invention are comprised of moving components that enable emptying a load of debris, including for example snow, leaves, dirt or other unwanted debris, by applying a generally downward force, preferably a downward stepping motion, to a an actuatable lever, such as a foot pedal. The actuatable lever is kinematically connected to a shovel. This kinematic connection can be via a number of pulley, lever, pneumatic, spring, or other energy transfer mediums, and is preferable one that is simple, cost effective, and effective in energy transfer. In some embodiments, the present invention is designed to simultaneous lift and tilt the shovel when the foot pedal is depressed, generating momentum towards up and forward direction to empty out the load from the shovel. This process enables the operator to utilize its body mass, gravity (a free form of acceleration), and its leg (the strongest muscle in her body), without subjecting back, shoulder, and arms to a possible injury due to strain.

Some aspects of the present invention include a shoveling and throwing device comprising: a frame, a manually operable lever, and a shovel, wherein the frame physically connects to the manually operable lever and shovel in manner so that an external force applied to the lever is mechanically transferred to the shovel so that the shovel can accelerate to expel material captured in the shovel.

The frame comprises a sturdy framework that can support a shovel and a lever, in addition to various debris that can be scooped or pushed onto the shovel. Furthermore, the frame can support the force of a person stepping, pressing, or kicking down on a lever connected to the frame. The frame can be made of either a single piece or comprised of multiple components that are assembled to meet the most economical packaging, and be made of any suitable material that can be manipulated and manufactured into a frame including wood, plastic, metal, or like materials, and preferably a material that is inexpensive and more preferably a lightweight material. In some embodiments, the frame is comprised of an upper frame and a lower frame. The upper frame can have a first and second end, and in some embodiments the second end of said upper frame comprising a handle. Some embodiments have a lower frame having a first and second end, and at least one wheel disposed on the first end of said frame. The second end of the lower frame is physically attached to said first end of said upper frame. In some embodiments, an extension can extend generally upwardly from the upper frame.

The actuatable lever is connected to the frame in a moveable manner, including for example fixed to the frame pivotally or rotatably using a pin, or a hinge, or a sliding mechanism that enables simultaneous rotation and translation displacement. In some embodiments the actuatable lever comprises a first end that is pivotally attached to the frame. The actuatable lever can be comprised of a first end that is pivotally attached proximate to the first end of the frame, and the actuatable lever can have a second end available for actuating by a user of the device. The second end can include a pedal, platform, rubber mat, or other flat surface that provides a surface area to accept a foot of a user and limit slippage.

The shovel can be a shovel generally available to a consumer, and includes plastic and metal shovels without the handle. The shovel is connected to the frame via an arm. The shovel can be in one position that rests close to the frame, or directly or indirectly on the frame, where it can be used to provide stability when the wheels are in motion. Upon actuating the lever, and having the energy transfer to the arm of the shovel, the shovel can swing away from the frame in a forceful manner such that the debris on the shovel can be expelled away from the frame.

In some embodiments, the device further comprises a three member system that is capable of transferring energy from the actuatable lever to the moveable shovel. The first member can have a first and second end, where the first end of the first member is pivotally attached to the frame extension. The second member can have a first and second end, where the first end of the second member can be pivotally attached proximate to the second end of the actuatable lever, and the second member is extending generally upwardly. The third member can have a first and second end, where the first end of the third member can be pivotally attached to the second end of the second member. In some embodiments, the shovel is pivotally attached to the second end of the third member, and the shovel is additionally pivotally attached at blade end to second end of the first member. This system along with the other elements of the device result in the depressing of the actuatable lever to cause the blade end of the shovel to elevate to a second position so as to empty material accumulated on the shovel.

In some embodiments the apparatus comprises the frame comprising at least one extension extending generally upwardly, the first end of the frame comprising wheels, second end of the frame comprising a handle; (b) an actuatable lever having a first end capped by a stopper and pivotally attached to the frame, the manually operable lever having a second end which when depressed causes the shovel to elevate to a second position so as to empty the material accumulated on the shovel and when released returns the shovel to its first position; (d) a first member pivotally attached to the shovel at a first end and pivotally attached to the frame extension; (e) a second member pivotally attached to the manually operable lever near a first end, the second member having a second end; and (f) a third member pivotally attached to the second end of the second member at a first end and to the shovel blade at a second end.

In some embodiments there are methods of manually moving and displacing large quantities of debris, comprising using the described shoveling and throwing devices. These methods include completing the steps of moving the device in a generally forward direction across a surface having debris in order to accumulate said debris in said shovel; and depressing the actuatable lever in a forceful manner to transfer the force from said actuatable lever to said shovel to expel said debris away from said device. The method can be performed wherein the debris accumulated on the shovel is W, and wherein the depressing step is performed with a force F; wherein force F is the force required on said pedal to maintain equilibrium with the weight of the accumulated material W according to the formula:

$$F = ( \frac{( W \times {L}_{1} \times {L}_{3} \times ( cos α ) )}{( {L}_{2} \times ( cos χ ) \times ( cos β ) )} ) \times ( \frac{( cos χ ) \times ( cos δ ) - ( cos χ ) \times ( cos δ )}{( {L}_{3} + {L}_{4} ) \times ( cos δ ) )} )$$

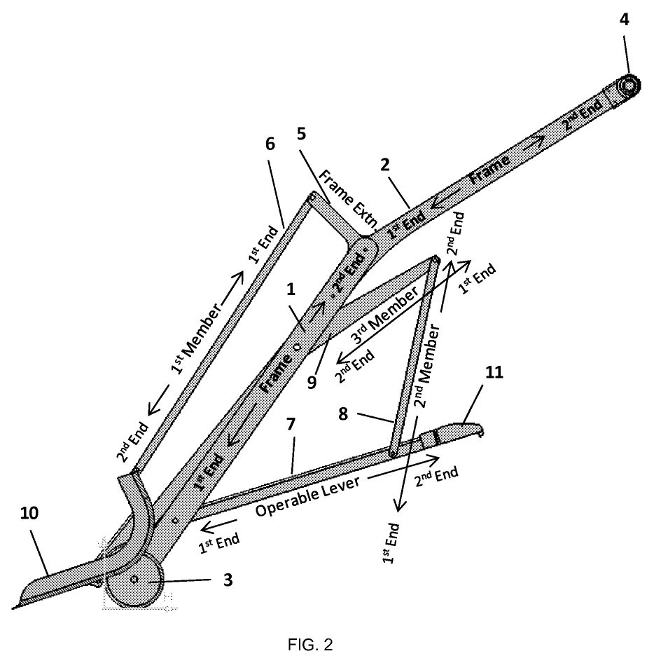

In one preferred embodiment which is shown in FIG. 2, there are the following: lower frame 1 has a first end having wheels 3 disposed thereon and a second end affixed to first end of upper frame 2, and second end of upper frame 2 having a handle 4. Frame extension 5 extends upwardly from upper frame 2 as an integral part of upper frame 2. Alternatively, the frame extension(s) may be an integral part of the lower frame 1 itself, or be a separate piece that is mounted onto either lower frame 1 or upper frame 2.

A first member 6 is pivotally attached near the top edge of the shovel 10 on one end and is pivotally attached to frame extension 5 on the other.

Manually operable lever 7 has a first end pivotally attached to the lower frame 1 and second end of the manually operable lever 7 is provided with a pedal 11 on which a user may exert a downward force to actuate the device. Between the first end of manually operable lever 7 and the pedal 11, the first end of second member 8 is pivotally attached, which may be adjustable so as to permit the user to vary the attachment point and correspondingly vary the amount of effort required to raise the shovel with a commensurate change in the maximum height to which the shovel can be raised. Second member 8 is also pivotally attached to third member 9, where the attachment point of the second and third member may be similarly adjustable. Third member 9 is pivotally attached to the rear of shovel 10.

Alternatively, second member 8 may be a spring which is connected on one end to manually operable lever 7 and on its other end to third member 9. In those embodiments where second member 8 is a spring, a spring having a sufficient modulus of resilience should be selected so as to enable non-linear acceleration of the shovel towards its fully extended position.

When the user has advanced the shovel and throwing device of the present invention as far forward as desired, or capable, the user depresses the pedal 11 to cause manually operable lever 7 to impart a downward force on second member 8 (optionally, second member 8 may be a spring), thereby, rotating third member 9 about a pivotal attachment point on frame 1. Correspondingly, shovel 10 rises from its first position a distance related to the depression of the pedal.

Although a wide variety of materials may be used to construct a shovel and throwing device according to the present invention, including HDPE, PP, or nylon resins; sp, aluminum, metal alloy, wood, or other firm but inexpensive materials; the following table details the preferred material for each component.

| Component Name | Material |
|---|---|
| Upper frame | Resin (HDPE, PP or Nylon) |
| Lower frame | Resin (HDPE, PP or Nylon) |
| Handle | Resin (HDPE, PP or Nylon) |
| First member | SP or Aluminum |
| Manually operable lever | SP or Aluminum |
| Second member | SP or Aluminum |
| Third member | Resin (HDPE, PP or Nylon) |
| Shovel | Resin (HDPE, PP or Nylon) |
| Foot pedal | Resin (HDPE, PP or Nylon) |
| Stopper | Resin (HDPE, PP or Nylon) |

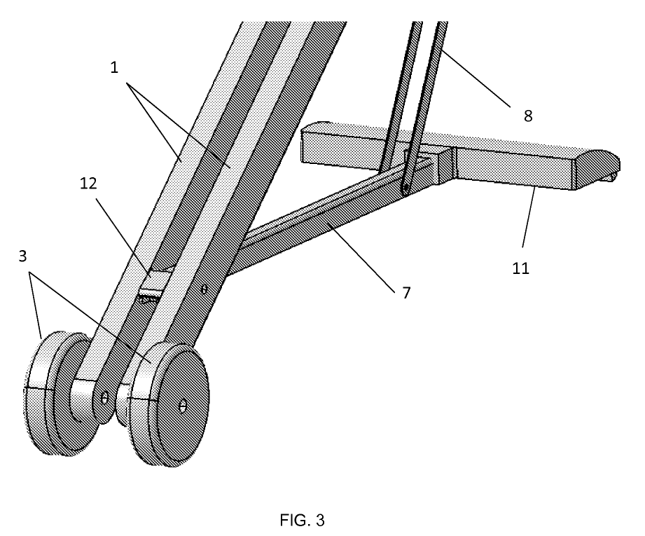

FIG. 3 represents a stopper 12 mounted to the first end of manually operable lever 7 to make contact with the third member 9 when it is in its first position.

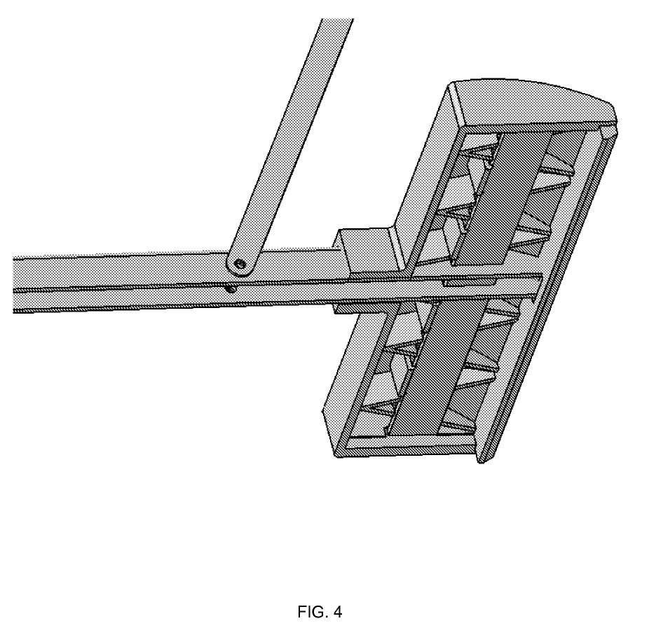

FIG. 4 illustrates attached view of pedal 11 to the second end of the manually operable lever 7

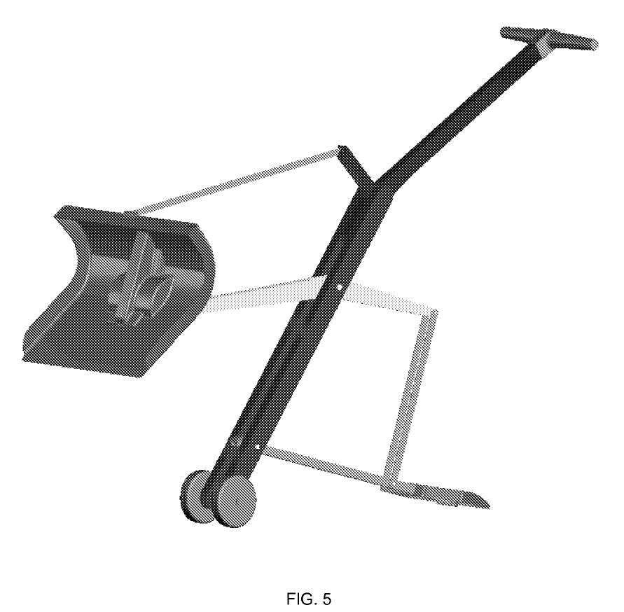

FIG. 5 represents the shovel and throwing device of the present invention in its second position when the pedal is fully depressed (i.e., pressed to the ground).

In view of the present disclosure or through practice of the present invention, it will be within the ability of one of ordinary skill to make modifications to the present invention, such as through the use of equivalent arrangements and compositions, in order to practice the invention without departing from the spirit of the invention as reflected in the appended claims.

What is claimed is:

1. A shoveling and throwing device for manually moving quantities of debris from a surface, comprising:
a frame for supporting the device comprising a first end having a handle, and a second end having a wheel for aiding a lateral movement of said device on a surface;
an actuatable lever that is capable of receiving a generally downward force from a user of said device; and
a moveable shovel that can receive and move debris off a surface; and wherein:
said actuatable lever and said moveable shovel is physically connected to said frame so that the actuatable lever when actuated by a downward force, said downward force is transferred to said shovel so that said shovel rapidly moves away from the frame to expel said debris on said shovel.

2. The shoveling and throwing device of claim 1 wherein said frame is comprised of multiple components collapsible for storage.

3. The shoveling and throwing device of claim 1 comprising:
an upper frame having a first and second end, said second end of said upper frame comprising a handle;
a lower frame having a first and second end, and at least one wheel disposed on said first end of said frame, said second end of said lower frame is physically attached to said first end of said upper frame.

4. The shoveling and throwing device of claim 3, wherein said upper frame further comprises at least one frame extension extending generally upwardly.

5. The shoveling and throwing device of claim 1, wherein said actuatable lever comprises a first end that is pivotally attached to said frame.

6. The shoveling and throwing device of claim 4, wherein said actuatable lever comprises a first end that is pivotally attached to said frame.

7. The shoveling and throwing device of claim 6, wherein said actuatable lever comprises a first end that is pivotally attached proximate to said first end of said frame, said actuatable lever having a second end available for actuating by a user.

8. The shoveling and throwing device of claim 7, further comprising:
a first member having a first and second end, said first end of said first member pivotally attached to said frame extension;
a second member having a first and second end, said first end of said second member pivotally attached proximate to said second end of said actuatable lever, said second member extending upwardly; and
a third member having a first and second end, said first end of said third member pivotally attached to said second end of said second member.

9. The shoveling and throwing device of claim 8, wherein
said shovel is pivotally attached to said second end of said third member, and said shovel additionally pivotally attached at blade end to second end of said first member, wherein depressing said actuatable lever causes said blade end of said shovel to elevate to a second position so as to empty material accumulated on said shovel.

10. The shoveling and throwing device according of claim 1 further comprising a stopper disposed on said first end of said manual operable lever.

11. The shoveling and throwing device according to claim 1 additionally comprising a pedal disposed on said second end of said actuatable lever.

12. A method of manually moving and displacing large quantities of debris, comprising:
moving the device of claim 1 in a generally forward direction across a surface having debris in order to accumulate said debris in said shovel;
depressing the actuatable lever in a forceful manner to transfer the force from said actuatable lever to said shovel to expel said debris away from said device.

13. The method of claim 12, wherein the debris accumulated on the shovel is W, and wherein the depressing step is performed with a force F; wherein force F is the force required on said pedal to maintain equilibrium with the weight of the accumulated material W according to the formula:
$$F = ( \frac{( W \times {L}_{1} \times {L}_{3} \times ( cos α ) )}{( {L}_{2} \times ( cos χ ) \times ( cos β ) )} ) \times ( \frac{( cos χ ) \times ( cos δ ) - ( cos χ ) \times ( cos δ )}{( {L}_{3} + {L}_{4} ) \times ( cos δ ) )} )$$

14. A method of manually moving and displacing large quantities of debris, comprising:
moving the device of claim 10 in a generally forward direction across a surface having debris in order to accumulate said debris in said shovel;
depressing the actuatable lever in a forceful manner to transfer the force from said actuatable lever to said shovel to expel said debris away from said device.

15. The method of claim 14, wherein the debris accumulated on the shovel is W, and wherein the depressing step is performed with a force F; wherein force F is the force required on said pedal to maintain equilibrium with the weight of the accumulated material W according to the formula:
$$F = ( \frac{( W \times {L}_{1} \times {L}_{3} \times ( cos α ) )}{( {L}_{2} \times ( cos χ ) \times ( cos β ) )} ) \times ( \frac{( cos χ ) \times ( cos δ ) - ( cos χ ) \times ( cos δ )}{( {L}_{3} + {L}_{4} ) \times ( cos δ ) )} )$$
